(19) United States
(12) Patent Application Publication
(10) Pub. No.: US 2011/0053760 A1
(43) Pub. Date: Mar. 3, 2011

(54) WATER-BASED METHODS FOR PRODUCING HIGH GREEN DENSITY AND TRANSPARENT ALUMINUM OXYNITRIDE (ALON)

(76) Inventors: Lior Miller, Kiryat Tivon (IL); Wayne D. Kaplan, Kiryat Tivon (IL)

(21) Appl. No.: 12/681,432

(22) PCT Filed: Oct. 2, 2008
(86) PCT No.: PCT/IL08/01309

§ 371 Date: Apr. 2, 2010

Related U.S. Application Data
(60) Provisional application No. 60/960,509, filed on Oct. 2, 2007.

(51) Int. Cl. C04B 35/58; C01B 21/082; C04B 35/64

(52) U.S. Cl. 501/152; 423/385; 501/153

(57) ABSTRACT

The present invention provides a water-based method for producing Aluminum oxynitride (AION) green bodies characterized by a density of at least 99% as measured according to ASTM C20-92 and/or at least 60% as measured by green density measurements The method comprises steps selected from (a) ball-milling Alumina powder and deflocculant in water for a period of time t, said t is between about 10 hours and about 24 hours, (b) homogeneously dispersing AIN in said ball-milled product for a period of time t1, said t1 is between about 0.5 hours and about 4 hours, (c) vacuum drying said product, thereby providing dense green bodies, and, (d) sintering said dense green bodies at temperature T1 in nitrogen for several time durations t2, said t2 is between about 0.5 hours and about 10 hours, said Tï is between about 1700 degrees C. and about 2100 degrees C.

### FIELD OF THE INVENTION

The invention generally pertains inter alia to a compound and a water-based method for producing Aluminum oxynitride (AlON) green bodies with a relatively high green density. The invention also teaches e.g., an AlON characterized by a green density of 67% as measured by conventional density measurements.

### BACKGROUND OF THE INVENTION

The present invention relates to a compound and a water-based method for producing. Aluminum oxynitride (AlON) green bodies with a relatively high green density.

Aluminum oxynitride (AlON) is a polycrystalline ceramic material with high potential use in applications requiring high strength combined with optical transparency

There is a need for such compounds in applications requiring substantial transmission and high strength. These requirements can be found in both military and commercial applications.

Aluminum oxynitride (AlON) was described in many articles and patents. For example, U.S. Pat. No. 4,520,116 describes polycrystalline cubic aluminum oxynitride having high theoretical density. Another example is U.S. Pat. No. 4,241,000 which describes a method for producing a sintered aluminum oxynitride body. In the method precursor powders are mixed and the sintering step is used to sinter the precursor powders to produce an aluminum oxynitride body. U.S. Pat. No. 4,241,000 also describes aluminum oxynitride having high theoretical density. None of them describe high density aluminum oxynitride which has a water based production process. Due to its cubic spinel structure, polycrystalline AlON has isotropic optical and thermal properties, making it a candidate material to replace single crystal forms of oxides currently in use for optical applications.

The first to report stabilization of □-alumina in a nitrogen atmosphere and the formation of a new spinel structure in the Al₂O₃—AlN system were Yamaguchi and Yanagida.

Adams et al. and Long and Foster investigated the Al₂O₃—AlN system during the 1960's. McCauley and co-workers proposed a structural model (constant anion model) for AlON in 1978 In addition, they published several reports on processing transparent polycrystalline AlON and analysis of the Al₂O₃—AlN phase diagram. More recently, Tabary and Servant published an updated phase diagram based on thermodynamic calculations, and characterized the crystallographic structure of phases in this system using neutron diffraction and high resolution transmission electron microscopy (HRTEM).

Fang et al. published a structural model based on Ab Initio calculations that supports the constant anion model.

While there are many different reactions leading to the formation of AlON, most reactions and synthesis have used two different processing approaches.

The first process is based on reacting alumina and aluminum nitride powders in nitrogen, in temperature above 1650° C. according to the following reaction:

9Al₂O₃+5AlN [symbol] Al₂₃O₂₇N₅ (1)

It should be pointed out that sintering can be performed either in (i) one step by reactive sintering of Al₂O₃ and AlN powders, or (ii) in two steps by first reacting the Al₂O₃ and AlN powders to form AlON followed by densification of the AlON powder.

The reactivity of AlN in the presence of water or humidity is a well known phenomenon which is considered to be a drawback in this case, and hence conventional methods use organic liquids as a medium for ball-milling.

Maghsoudipour et al. calculated a volume expansion of 2.8% during this reaction, and a linear expansion of 0.9%. They have proven this expansion experimentally by dilatometry.

Bandyopadhyay et al. found that the reaction is completed within less than 30 minutes at Temperature greater than or equals to ≧1800° C.

The second processing approach is based on carbothermal reduction of alumina in the presence of carbon and nitrogen above 1700° C. according to the following reaction:

23Al₂O₃+15C+5N₂ [symbol] 2Al₂₃O₂₇N₅+15CO (2)

This process was first reported by Ish-Shalom, where AlON is an intermediate compound in the reduction of alumina to aluminum nitride.

Nakao and Fukuyama used this approach to form single crystal AlN from sapphire. The AlON layer which was formed spontaneously between the two crystals was used as a buffer to reduce the lattice mismatch. Zheng and Forslund prepared AlON powder based on carbothermal reduction of Al₂O₃. They found that increasing the gas pressure results in a decrease in the reaction rate. In addition, they found that a two step process, which includes a reduction of Al₂O₃ at a temperature below that required for AlON formation, results in a higher reaction rate.

This may be due to a combination of the two processes (carbothermal reduction and reaction sintering).

Yawei et al. compared these two approaches to find the temperature needed to produce AlON powder. They found that the temperature should be above 1650° C., but can be lowered if MgO or MgAl₂O₄ additives are introduced.

In addition, they found that carbothermal reduction results in higher purity AlON compared to reaction sintering.

However, too much carbon results in the reduction of AlON to AlN.

Hence, this process-strongly depends on the raw materials and the sintering condition used.

The present invention also relates to the Hydrolysis Assisted Solidification reaction.

The term “Hydrolysis Assisted Solidification (HAS)” refers herein after to a process for forming ceramic green bodies from aqueous suspensions which was patented by Kosmac et al. in 1995.

In the HAS process, the reactivity of AlN with water, which is a well known phenomenon, is used to form a rigid network of aluminum hydroxide according to the following 3 reactions:

AlN+2H₂O [symbol] AlOOH+NH₃ (3)

NH₃+H₂O [symbol] NH₄⁺+OH⁻ (4)

AlOOH+H₂O [symbol] Al(OH)₃ (5)

During this process, which is thermally activated, the slip viscosity increases due to three main reasons:

(1) water is consumed;
(2) ammonia is formed and released; and,
(3) aluminum hydroxide gel is formed.

Kosmac and co-workers used this process for the production of complex-shaped ceramic green bodies.

The term “green density” refers herein after as the density of the ceramic body before sintering. Li et al. used this process for forming SiC. This concept involves small additions of AlN to the ceramic suspension which results in water consumption and an increase in the pH level. These two parameters increase the slip viscosity until the fluid character of the suspension is lost. The hydrolysis reaction does not begin immediately when the AlN is introduced to the slurry, but rather there is an incubation period that depends on the slurry pH and the thickness of the oxide layer around the AlN particles.

During this period, the AlN particles are dispersed within the slurry. Yawei et al. reported that the aluminum hydroxide network transforms to Al₂O₃ below 400° C. in air.

As described above, while conventional methods use alcohol as a medium for ball-milling, the present invention will utilize water to form a rigid network of aluminum hydroxide in green Al₂O₃—AlN preforms whilst producing green bodies having a relatively high green density compared to said conventional methods.

Therefore, there is a great potential and an unmet need for using the HAS reaction during the processing of AlON; thereby providing a water-based method for producing AlON whilst maintaining high densities of the same.

### SUMMARY OF THE INVENTION

It is one object of the present invention to provide a compound comprising sintered Aluminum oxynitride (AlON), characterized by a density of at least 99% as measured according to ASTM C20-92.

It is another object of the present invention to provide a compound comprising green dense Aluminum oxynitride (AlON), characterized by green density of at least 60% as measured by green density measurements.

It is another object of the present invention to provide a water-based method for producing Aluminum oxynitride (AlON) green bodies with a relatively high green density. The method comprising steps selected inter alia from:
a. ball-milling Alumina powder or Al₂O₃ and deflocculant in water for a period of time t;
b. homogeneously dispersing AlN in said ball-milled product for a period of time t1;
c. vacuum drying said product; thereby providing dense green bodies;
d. sintering said dense green bodies at temperature T1 in nitrogen for several time durations t2;
wherein the density of said sintered bodies is of at least 99% as measured according to ASTM C20-92; further wherein said the density of said green bodies is of at least 60% as measured by green density measurements.

It is another object of the present invention to provide the method as defined above, wherein said period of time t is greater than about 10 hours and lower than about 24 hours.

It is another object of the present invention to provide the method as defined above, wherein said temperature T1 is greater than about 1700° C. and lower than about 2100° C.

It is another object of the present invention to provide the method as defined above, wherein said time duration t2 is greater than about 0.5 hours and lower than about 10 hours.

It is another object of the present invention to provide the method as defined above, wherein said time duration t1 is greater than about 0.5 hours and lower than about 4 hours.

It is another object of the present invention to provide the method as defined above, wherein said step of sintering additionally comprising step of applying pressure of about 10-200 MPa.

It is another object of the present invention to provide the method as defined above, wherein said deflocculant is selected from a group consisting of poly acrylic acid.

It is another object of the present invention to provide an Aluminum oxynitride (AlON) green bodies having high green density, prepared by steps of:
a. ball-milling Alumina powder and deflocculant in water for a period of time t; said t is greater than about 10 hours and lower than about 24 hours;
b. homogeneously dispersing AlN in said ball-milled product for a period of time t1; said t1 is greater than about 0.5 hours and lower than about 4 hours;
c. vacuum drying said product; thereby providing dense green bodies;
d. sintering said dense green bodies at temperature T1 in nitrogen for several time durations t2; said t2 is greater than about 0.5 hours and lower than about 10 hours; said T1 is greater than about 1700° C. and lower than about 2100° C.;
wherein the density of said sintered bodies is of at least 95% as measured according to ASTM C20-92; further wherein said the density of said green bodies is of at least 50% as measured by green density measurements.

It is another object of the present invention to provide the method as defined above, additionally comprising step of adding about 1 wt. % MgO dopant in the form of salt which is soluble in water It is another object of the present invention to provide the method as defined above, additionally comprising step of adding about 1 wt. % La₂O₃ dopant in the form of salt which is soluble in water.

It is another object of the present invention to provide the method as defined above, additionally comprising step of adding about 1 wt. % Y₂O₃ dopant in the form of salt which is soluble in water.

It is another object of the present invention to provide a compound comprising green dense Aluminum oxynitride (AlON), characterized by green density of at least 67% as measured by density measurements.

It is another object of the present invention to provide a water-based method for producing Aluminum oxynitride (AlON) green bodies with a relatively high green density, said method comprising steps of:
a. ball-milling Al₂O₃ and deflocculant in water for a period of time t3;
b. homogeneously dispersing AlN in said ball milled product for a period of time t4;
c. pressure filtering said product; thereby providing dense green bodies;
d. removing NH3 by vacuum drying said filtered slip;
e. performing polymer burnout at temperature T2;
f. sintering the product of step (e) at temperature T3 in nitrogen for several time durations t5;
wherein the density of said sintered bodies is of at least 95% as measured according to ASTM C20-92; further wherein said the density of said green bodies is of at least 60% as measured by green density measurements.

It is another object of the present invention to provide the method as defined above, wherein said step of pressure filtering is performed at about 7 MPa.

It is another object of the present invention to provide the method as defined above, wherein said temperature T2 is greater than about 400° C. and lower than about 800° C.

It is another object of the present invention to provide the method as defined above, wherein said temperature T3 is greater than about 1700° C. and lower than about 2100° C.

It is another object of the present invention to provide the method as defined above, wherein said time duration t5 is greater than about 0.5 hours and lower than about 10 hours.

It is another object of the present invention to provide the method as defined above, wherein said time duration t3 is greater than about 10 hours and lower than about 48 hours.

It is another object of the present invention to provide the method as defined above, wherein said time duration t4 is greater than about 0.5 hours and lower than about 4 hours.

It is another object of the present invention to provide the method as defined above, wherein said step of sintering additionally comprising step of applying pressure of about 10-200 MPa

It is another object of the present invention to provide the method as defined above, wherein said deflocculant is selected from a group consisting of poly acrylic acid.

It is another object of the present invention to provide an Aluminum oxynitride (AlON) green bodies having high green density, prepared by steps of:
a. ball-milling Al₂O₃ and deflocculant in water for a period of time t3; said t3 is greater than about 10 hours and lower than about 48 hours;
b. homogeneously dispersing AlN in said ball milled product for a period of time t4; said t4 is greater than about 0.5 hours and lower than about 4 hours;
c. pressure filtering said product; thereby providing dense green bodies;
d. removing NH3 by vacuum drying said filtered slip;
e. performing polymer burnout at temperature T2; said T2 is greater than about 400° C. and lower than about 800° C.;
f. sintering the product of step (e) at temperature T3 in nitrogen for several time durations t5; said t5 is greater than about 0.5 hours and lower than about 10 hours; said T3 is greater than about 1700° C. and lower than about 2100° C.;
wherein the density of said sintered bodies is of at least 99% as measured according to ASTM C20-92; further wherein said the density of said green bodies is of at least 60% as measured by green density measurements.

It is another object of the present invention to provide the method as defined above, additionally comprising step of adding about 1 wt. % MgO dopant in the form of salt which is soluble in water.

It is another object of the present invention to provide the method as defined above, additionally comprising step of adding about 1 wt. % La₂O₃ dopant in the form of salt which is soluble in water.

It is another object of the present invention to provide the method as defined above, additionally comprising step of adding about 1 wt. % Y₂O₃ dopant in the form of salt which is soluble in water.

It is another object of the present invention to provide an article of manufacturing, comprising a compound having green dense Aluminum oxynitride (AlON); said AlON is characterized by a green density of at least 60% as measured by density measurements.

It is another object of the present invention to provide an article of manufacturing, comprising a compound having sintered Aluminum oxynitride (AlON); said sintered AlON is characterized by a density of at least 99% as measured according to ASTM C20-92.

It is another object of the present invention to provide an article of manufacturing, comprising a compound having green dense Aluminum oxynitride (AlON); said AlON is characterized by a green density of at least 67% as measured by density measurements.

The following publications are incorporated within the present invention as references, namely: N. D. Corbin, Aluminum Oxynitride Spinel: A Review, Journal of the European Ceramic Society, 5[3]: 143-154, 1989; A. Pallone, J. Demaree & J. Adams, Application of Nondestructive Ion Beam Analysis to Measure Variations in the Elemental Composition of Armor Materials, Nuclear Instruments and Methods in Physics Research Section B: Beam Interactions with Materials and Atoms, 219-220: 755-758, 2004; T. Sekine, X. Li, T. Kobayashi, Y. Yamashita, P. Patel & J. W. McCauley, Aluminum Oxynitride at Pressures up to 180 GPa, Journal of Applied Physics, 94[8]: 4803-4806, 2003; T. M. Hartnett, S. D. Bernstein, E. A. Maguire & R. W. Tustison, Optical Properties of AlON (Aluminum Oxynitride), Infrared Physics & Technology, 39[4]: 203-211, 1998; T. M. Hartnett, S. D., Bernstein, E. A. Maguire & R. W. Tustison, Optical Properties of AlON (Aluminum Oxynitride), Proceedings of SPIE—The International Society for Optical Engineering, 3060[Window and Dome Technologies and Materials V]: 284-295, 1997; T. M. Hartnett & R. L. Gentilman, Optical and Mechanical Properties of Highly Transparent Spinel and AlON Domes, Proceedings of SPIE—The International Society for Optical Engineering, 505[Adv. Opt. Mater.]: 15-22, 1984; P. J. Patel, G. A. Gilde, P. G. Dehmer & J. W. McCauley, Transparent Ceramics for Armor and EM Window Applications, Proceedings of SPIE—The International Society for Optical Engineering, 4102[Inorganic Optical Materials II]: 1-14, 2000; P. J. Patel, J. J. Swab & G. A. Gilde, Fracture Properties and Behavior of Transparent Ceramics, Proceedings of SPIE—The International Society for Optical Engineering, 4102[Inorganic Optical Materials II]: 15-24, 2000; G. Yamaguchi, Refractive Power of the Lower-Valent Aluminum Ion (Al+ or Al++) in the Crystal, Bulletin of the Chemical Society of Japan, 23: 89-90, 1950; G. Yamaguchi & H. Yanagida, The Reducing Spinel: A New Spinel Formula AlN—Al2O3 Instead of the Previous One Al3O4, Bulletin of the Chemical Society of Japan, 32: 1264-5, 1959; I. Adams, T. R. AuCoin & G. A. Wolff, Luminescence in the System Al2O3—AlN, Journal of the Electrochemical Society, 109: 1050-4, 1962; G. Long & L. M. Foster, Crystal Phases in the System Al2O3—AlN, Journal of the American Ceramic Society, 44: 255-8, 1961; N. D. Corbin, Aluminum Oxynitride Spinel: A Review, Journal of the European Ceramic Society, 5[3]: 143-154, 1989; J. W. McCauley, Simple-Model for Aluminum Oxynitride Spinels, Journal of the American Ceramic Society, 61[7-8]: 372-373, 1978; J. W. McCauley & N. D. Corbin, Phase-Relations and Reaction Sintering of Transparent Cubic Aluminum Oxynitride Spinel (AlON), Journal of the American Ceramic Society, 62[9-10]: 476-479, 1979; N. D. Corbin & J. W. McCauley, Nitrogen-Stabilized Aluminum-Oxide Spinel (AlON), Proceedings of the Society of Photo-Optical Instrumentation Engineers, 297: 19-23, 1981; J. W. McCauley & N. D. Corbin, High Temperature Reactions and Microstructures in the Aluminum Oxide-Aluminum Nitride System, NATO ASI Series, Series E: Applied Sciences, 65[Prog. Nitrogen Ceram.]: 111-18, 1983; P. Tabary & C. Servant, Thermodynamic Reassessment of the AlN—Al2O3 System, Calphad-Computer Coupling of Phase Diagrams and Thermochemistry, 22[2]: 179-201, 1998; P. Tabary. & C. Servant, Crystalline and Microstructure Study of the AlN—Al2O3 Section in the Al—N—O System. I. Polytypes and Gamma-AlON Spinel Phase, Journal of Applied Crystallography, 32: 241-252, 1999; P. Tabary & C. Servant, Crystalline and Microstructure Study of the AlN—Al2O3 Section in the Al—N—O System. II. Phi′- and Delta-AlON Spinel Phases, Journal of Applied Crystallography, 32: 253-272, 1999; P. Tabary, C. Servant & M. Guymont, High-Resolution Transmission Electron Microscopy Study of the Phi′- and Delta-AlON Spinel Phases of the Pseudo-Binary Section AlN—Al2O3, Journal of Applied. Crystallography, 32: 755-760, 1999; C. M. Fang, R. Metselaar, H. T. Hintzen & G. de With, Structure Models for Gamma-Aluminum Oxynitride from Ab Initio Calculations, Journal of the American Ceramic Society, 84[11]: 2633-2637, 2001; J. W. McCauley & N. D. Corbin, Phase-Relations and Reaction Sintering of Transparent Cubic Aluminum Oxynitride Spinel (AlON), Journal of the American Ceramic Society, 62[9-10]: 476-479, 1979; J. W. McCauley & N. D. Corbin, Phase-Relations and Reaction Sintering of Transparent Cubic Aluminum Oxynitride Spinel (AlON), Journal of the American Ceramic Society, 62[9-10]: 476-479, 1979; J. W. McCauley & N. D Corbin, Process for Producing Polycrystalline Cubic Aluminum Oxynitride, U.S. Pat. No. 4,241,000 23 Dec. 1980; Y. W. Kim, H. C. Park, Y. B. Lee, K. D. Oh & R. Stevens, Reaction Sintering and Microstructural Development in the System Al2O3—AlN, Journal of the European Ceramic Society, 21[13]: 2383-2391, 2001; R. L. Gentilman, E. A. Maguire & L. E. Dolhert, Transparent Aluminum Oxynitride and Method of Manufacture, U.S. Pat. No. 4,520,116, 28 May 1985; R. L. Gentilman, E. A. Maguire & L. E. Dolhert, Transparent Aluminum Oxynitride and Method of Manufacture, U.S. Pat. No. 4,720,362, 19 Jan. 1988; R. Gentilman, E. Maguire, T. Kohane & D. B. Valentine, Comparison of Large AlON and Sapphire Windows, Proceedings of SPIE—The International Society for Optical Engineering, 1112[Window Dome Technol Mater.]: 31-9, 1989; S, Novak & T. Kosmac, Interactions in Aqueous Al2O3—AlN Suspensions During the HAS Process, Materials. Science and Engineering A, 256[1-2]: 237-242, 1998; A. Maghsoudipour, M. A. Bahrevar, J. G. Heinrich & F. Mortarzadeh, Reaction Sintering of AlN—AlON Composites, Journal of the European Ceramic Society, 25[7] 1067-1072, 2005; S. Bandyopadhyay, G. Rixecker, F. Aldinger, S. Pal, K. Mukherjee & H. S. Maiti, Effect of Reaction Parameters on Gamma-AlON Formation From Al2O3 and AlN, Journal of the American Ceramic Society, 85[4]: 1010-1012, 2002; L. Yawei, L. Nan & Y. Runzhang, The Formation and Stability of □-Aluminium Oxynitride Spinel in the Carbothermal Reduction and Reaction Sintering Processes, Journal of Materials Science, 32[4]: 979-982, 1997; L. Yawei, L. Nan. & Y. Runzhang., Carbothermal Reduction Synthesis of Aluminium Oxynitride Spinel Powders at Low Temperatures, Journal of Materials Science Letters, 16[3]: 185-186, 1997; M. Ish-Shalom, Formation of Aluminum Oxynitride by Carbothermal Reduction of Aluminum Oxide in Nitrogen, Journal of Materials Science Letters, 1[4]: 147,9, 1982; W. Nakao & H. Fukuyama, Single Crystalline AlN Film Formed by Direct Nitridation of Sapphire Using Aluminum Oxynitride Buffer, Journal of Crystal Growth, 259[3]: 302-308, 2003; J. Zheng & B. Forslund, Carbothermal Synthesis of Aluminium Oxynitride (AlON) Powder: Influence of Starting Materials and Synthesis Parameters, Journal of the European Ceramic Society, 15[11]: 1087-1100, 1995; L. Yawei, L. Nan & Y. Runzhang, The Formation and Stability of □-Aluminium Oxynitride Spinel in the Carbothermal Reduction and Reaction Sintering Processes, Journal of Materials Science, 32[4]: 979-982, 1997; L. Yawei, L. Nan. & Y. Runzhang., Carbothermal Reduction Synthesis of Aluminium Oxynitride Spinel Powders at Low Temperatures, Journal of Materials Science Letters, 16[3]: 185-186, 1997; L. Yawei, L. Nan & Y. Runzhang, The Formation and Stability of □-Aluminium Oxynitride Spinel in the Carbothermal Reduction and Reaction Sintering Processes, Journal of Materials Science, 32[4]: 979-982, 1997; M. Ish-Shalom, Formation of Aluminum Oxynitride by Carbothermal Reduction of, Aluminum Oxide in Nitrogen, Journal of Materials Science Letters, 1[4]: 147-9, 1982; L. Yawei, L. Nan & Y. Runzhang, Effect of Raw Materials on Carbothermal Reduction Synthesis of □-Aluminum Oxynitride Spinel Powder, Journal of Materials Science, 34[11]: 2547-2552, 1999; T. Kosmac, S, Novak, D. Eterovic & M. Sajko, A Process For Forming Ceramic Products From an Aqueous Suspension With a High Solids Content. SI Patent P-9500073, 9 Mar. 1995; T. Kosmac, S, Novak & K. Krnel, Hydrolysis Assisted Solidification (HAS) Process and Its Use in Ceramic Wet Forming, Zeitschrift fuer Metallkunde, 92[2]: 150-157, 2001; S, Novak, T. Kosmac, K. Krnel & G. Drazic, Principles of the Hydrolysis Assisted Solidification (HAS) Process for Forming Ceramic Bodies from Aqueous Suspension, Journal of the European Ceramic Society, 22[3]: 289-295, 2002; T. Kosmac, S, Novak & M. Sajko, Hydrolysis-Assisted Solidification (HAS): A New Setting Concept for Ceramic Net-Shaping, Journal of the European Ceramic Society, 17[2-3]: 427-432, 1997; S, Novak & T. Kosmac, Interactions in Aqueous Al2O3—AlN Suspensions During the HAS Process, Materials Science and Engineering A, 256[1-2]: 237-242, 1998; T. Kosmac, S, Novak & K. Krnel, Hydrolysis Assisted Solidification (HAS) Process and Its Use in Ceramic Wet Forming, Zeitschrift fuer Metallkunde, 92[2]: 150-157, 2001; S, Novak, T. Kosmac, K. Krnel & G. Drazic, Principles of the Hydrolysis Assisted Solidification (HAS) Process for Forming Ceramic Bodies from Aqueous Suspension, Journal of the European Ceramic Society, 22[3]: 289-295, 2002; T. Kosmac, S, Novak & M. Sajko, Hydrolysis-Assisted Solidification (HAS): A New Setting Concept for Ceramic Net-Shaping, Journal of the European Ceramic Society, 17[2-3]: 427-432, 1997; S, Novak & T. Kosmac, Interactions in Aqueous Al2O3—AlN Suspensions During the HAS Process, Materials Science and Engineering A, 256[1-2]; 237-242, 1998; W. Li, Z. Liu, M. Gu & Y. Jin, Hydrolysis Assisted Solidification of Silicon Carbide. Ceramics from Aqueous Suspension, Ceramics International, 31[1]: 159-163, 2005; T. Kosmac, S, Novak & K. Krnel, Hydrolysis Assisted Solidification (HAS) Process and Its Use in Ceramic Wet Forming, Zeitschrift fuer Metallkunde, 92[2]: 150-157, 2001; L. Yawei, L. Nan & Y. Runzhang, Effect of Raw Materials on Carbothermal Reduction Synthesis, of □-Aluminum Oxynitride Spinel Powder, Journal of Materials Science, 34[11]: 2547-2552, 1999; S. Bandyopadhyay, G. Rixecker, F. Aldinger, S. Pal, K. Mukherjee & H. S. Maiti, Effect of Reaction Parameters on Gamma-AlON Formation From Al2O3 and AlN, Journal of the American Ceramic Society, 85[4]: 1010-1012, 2002; A. Krell, P. Blank, H. W. Ma, T. Hutzler, M. P. B. van Bruggen & R. Apetz, Transparent Sintered Corundum with High Hardness and Strength, Journal of the American Ceramic Society, 86[1]: 12-18, 2003; A. Maghsoudipour, M. A. Bahrevar, J. G. Heinrich & F. Mortarzadeh, Reaction Sintering of AlN—AlON Composites, Journal of the European Ceramic Society, 25[7] 1067-1072, 2005; C. Martin & B. Cales, Synthesis and Hot Pressing of Transparent Aluminum Oxynitride, Proceedings of SPIE—The International Society for Optical Engineering, 1112[Window Dome Technol Mater.]: 20-4, 1989; N. D. Corbin, Aluminum Oxynitride Spinel: A Review, Journal of the European Ceramic Society, 5[3]: 143-154, 1989; A. Pallone, J. Demaree & J. Adams, Application of Nondestructive Ion Beam Analysis to Measure Variations in the Elemental Composition of Armor Materials, Nuclear Instruments and Methods in Physics Research Section B: Beam Interactions with Materials and Atoms, 219-220: 755-758, 2004; T. Sekine, X. Li, T. Kobayashi, Y. Yamashita, P. Patel & J. W. McCauley, Aluminum Oxynitride at Pressures up to 180 GPa, Journal of Applied Physics, 94[8]: 4803-4806, 2003; T. M. Hartnett, S. D. Bernstein, E. A. Maguire & R. W. Tustison, Optical Properties of AlON (Aluminum Oxynitride), Infrared Physics & Technology, 39[4]: 203-211, 1998; T. M. Hartnett, S. D. Bernstein, E. A. Maguire & R. W. Tustison, Optical Properties of AlON (Aluminum Oxynitride), Proceedings of SPIE—The International Society for Optical Engineering, 3060 [Window and Dome Technologies and Materials V]: 284-295, 1997; T. M. Hartnett & R. L. Gentilman, Optical and Mechanical Properties of Highly Transparent Spinel and AlON Domes, Proceedings of SPIE—The International Society for Optical Engineering, 505 [Adv. Opt. Mater.]: 15-22, 1984; P. J. Patel, G. A. Gilde, P. G. Dehmer & J. W. McCauley, Transparent Ceramics for Armor and EM Window Applications, Proceedings of SPIE—The International Society for Optical Engineering, 4102 [Inorganic Optical Materials II]: 1-14, 2000; P. J. Patel, J. J. Swab & G. A. Gilde, Fracture Properties and Behavior of Transparent Ceramics, Proceedings of SPIE—The International Society for Optical Engineering, 4102 [Inorganic Optical Materials II]: 15-24, 2000; J. W. McCauley & N. D Corbin, Process for Producing Polycrystalline Cubic Aluminum Oxynitride, U.S. Pat. No. 4,241,000 23 Dec. 1980; T. M. Hartnett, R. L. Gentilman & E. A. Maguire, Aluminum Oxynitride Having Improved Optical Characteristics and Method of Manufacture, U.S. Pat. No. 4,481,300, 6 Nov. 1984; R. L. Gentilman, E. A. Maguire & L. E. Dolhert, Transparent Aluminum Oxynitride and Method of Manufacture, U.S. Pat. No. 4,520,116, 28 May 1985; E. A. Maguire, T. M. Hartnett, & R. L. Gentilman, Method of Producing Aluminum Oxynitride Having Improved Optical Characteristics, U.S. Pat. No. 4,686,070, 11 Aug. 1987; R. L. Gentilman, E. A. Maguire & L. E. Dolhert, Transparent Aluminum Oxynitride and Method of Manufacture, U.S. Pat. No. 4,720,362, 19 Jan. 1988; I. Adams, T. R. AuCoin & G. A. Wolff, Luminescence in the System Al2O3—AlN, Journal of the Electrochemical Society, 109: 1050-4, 1962; G. Long & L. M. Foster, Crystal Phases in the System Al2O3—AlN, Journal of the American Ceramic Society, 44: 255-8, 1961; J. W. McCauley, Simple-Model for Aluminum Oxynitride Spinels, Journal of the American Ceramic Society, 61[7-8]; 372-373, 1978; J. W. McCauley & N. D. Corbin, Phase-Relations and Reaction Sintering of Transparent Cubic Aluminum Oxynitride Spinel (AlON), Journal of the American Ceramic Society, 62[9-10]: 476-479, 1979; N. D. Corbin & J. W. McCauley, Nitrogen-Stabilized Aluminum-Oxide Spinel (AlON), Proceedings of the Society of Photo-Optical Instrumentation Engineers, 297: 19-23, 1981; J. W. McCauley & N. D. Corbin, High Temperature Reactions and Microstructures in the Aluminum Oxide-Aluminum Nitride System, NATO ASI Series, Series E: Applied Sciences, 65[Prog. Nitrogen Ceram.]: 111-18, 1983; P. Tabary & C. Servant, Thermodynamic Reassessment of the AlN—Al2O3 System, Calphad-Computer Coupling of Phase Diagrams and Thermochemistry, 22[2]: 179-201, 1998; P. Tabary & C. Servant; Crystalline and Microstructure Study of the AlN—Al2O3 Section in the Al—N—O System. I. Polytypes and Gamma-AlON Spinel Phase, Journal of Applied Crystallography, 32: 241-252, 1999; P. Tabary & C. Servant, Crystalline and Microstructure Study of the AlN—Al2O3 Section in the Al—N—O System. II. Phi′- and Delta-AlON Spinel Phases, Journal of Applied Crystallography, 32: 253-272, 1999; P. Tabary, C. Servant & M. Guymont, High-Resolution Transmission Electron Microscopy Study of the Phi′- and Delta-AlON Spinel Phases of the Pseudo-Binary Section AlN—Al2O3, Journal of Applied Crystallography, 32: 755-760, 1999; T. Kosmac, S, Novak, D. Eterovic & M. Sajko, A Process For Forming Ceramic Products From an Aqueous Suspension With a High Solids Content. SI Patent P-9500073, 9 Mar. 1995; C. M. Fang, R. Metselaar, H. T. Hintzen & G. de With, Structure Models for Gamma-Aluminum Oxynitride from Ab Initio Calculations, Journal of the American Ceramic Society, 84[11]; 2633-2637, 2001; J. W. McCauley & N. D Corbin, Process for Producing Polycrystalline Cubic Aluminum Oxynitride, U.S. Pat. No. 4,241,000 23 Dec. 1980; Y. W. Kim, H. C. Park, Y. B. Lee, K. D. Oh. & R. Stevens, Reaction Sintering and Microstructural Development in the System Al2O3—AlN, Journal of the European Ceramic Society, 21[13]: 2383-2391, 2001; R. L. Gentilman, E. A. Maguire & L. E. Dolhert, Transparent Aluminum Oxynitride and Method of Manufacture, U.S. Pat. No. 4,520,116, 28 May 1985; R. L. Gentilman, E. A. Maguire & L. E. Dolhert, Transparent Aluminum Oxynitride and Method of Manufacture, U.S. Pat. No. 4,720,362, 19 Jan. 1988; T. Kosmac, S, Novak, D. Eterovic & M. Sajko, A Process For Forming Ceramic Products From an Aqueous Suspension With a High Solids Content. SI Patent P-9500073, 9 Mar. 1995; T. Kosmac, S, Novak & K. Krnel, Hydrolysis Assisted Solidification (HAS) Process and Its Use in Ceramic Wet Forming, Zeitschrift fuer Metallkunde, 92[2]: 150-157, 2001; S. I. Bae & S. Baik, Determination of Critical Concentration of Silica and/or Calcia for Abnormal Grain Growth in Alumina, Journal of the American Ceramic Society, 74[4] 1065-7, 1993; S. K. Roy & R. L. Coble, Solubilities of Magnesia, Titania, and Magnesium Titanate in Aluminum Oxide, Journal of the American Ceramic Society, 51[1] 1-6, 1968; W. C. Johnson & R. L. Coble, A Test of the Second-Phase and Impurity-Segregation Models for MgO-Enhanced Densification of Sintered Alumina, Journal of the American Ceramic Society, 61[3-4] 110-4 (1978); P. J. Jorgensen & J. H. Westbrook, Role of Solute Segregation at Grain Boundaries During Final-Stage Sintering of Alumina, Journal of the American Ceramic Society, 47[7] 332-8, 1964; J. G. J. Peelen, Influence of Magnesia on the Evolution of the Microstructure of Alumina, Materials Science Research, 10[Sintering Catal.]: 443-53, 1975; K. A. Berry & M. P. Harmer, Effect of MgO Solute on Microstructure Development in Al2O3, Journal of the American Ceramic Society, 69[2] 143-9, 1986; C. Greskovich & J. A. Brewer, Solubility of Magnesia in Polycrystalline Alumina at High Temperatures, Journal of the American Ceramic Society, 84[2] 420-5, 2001; A. Pallone, J. Demaree & J. Adams, Application of Nondestructive Ion Beam Analysis to Measure Variations in the Elemental Composition of Armor Materials, Nuclear Instruments and Methods in Physics Research Section B: Beam Interactions with Materials and Atoms, 219-220: 755-758, 2004; L. Miller, A. Avishai & W. D. Kaplan, Solubility Limit of MgO in Al2O3 at 1600° C., Journal of the American Ceramic Society, 89[1]: 350-353, 2006; Adams, T. R. AuCoin & G. A. Wolff, Luminescence in the System Al2O3—AlN, Journal of the Electrochemical Society, 109: 1050-4, 1962; G. Long & L. M. Foster, Crystal Phases in the System Al2O3—AlN, Journal of the American Ceramic Society, 44: 255-8, 1961; J. W. McCauley, Simple-Model for Aluminum Oxynitride Spinels, Journal of the American Ceramic Society, 61[7-8]: 372-373, 1978; J. W. McCauley & N. D. Corbin, Phase-Relations and Reaction Sintering of Transparent Cubic Aluminum Oxynitride Spinel (AlON), Journal of the American Ceramic Society, 62[9-10]: 476-479, 1979; N. D. Corbin & J. W. McCauley, Nitrogen-Stabilized Aluminum-Oxide Spinel (AlON), Proceedings of the Society of Photo-Optical Instrumentation Engineers, 297: 19-23, 1981; J. W. McCauley & N. D. Corbin, High Temperature Reactions and Microstructures in the Aluminum Oxide-Aluminum Nitride. System, NATO ASI Series, Series E: Applied Sciences, 65[Prog. Nitrogen Ceram.]: 111-18, 1983; P. Tabary & C. Servant, Thermodynamic Reassessment of the AlN—Al2O3 System, Calphad-Computer Coupling of Phase Diagrams and Thermochemistry, 22[2]: 179-201,1998; R. L. Gentilman, E. A. Maguire & L. E. Dolhert, Transparent Aluminum Oxynitride and Method of Manufacture, U.S. Pat. No. 4,720,362, 19 Jan. 1988; P. Tabary & C. Servant, Crystalline and Microstructure Study of the AlN—Al2O3 Section in the Al—N—O System. I. Polytypes and Gamma-AlON Spinel Phase, Journal of Applied Crystallography, 32: 241-252, 1999; P. Tabary & C. Servant, Crystalline and Microstructure Study of the AlN—Al2O3 Section in the Al—N—O System. I. Polytypes and Gamma-AlON Spinel Phase, Journal of Applied Crystallography, 32: 241-252, 1999; R. Gentilman, E. Maguire, T. Kohane & D. B. Valentine, Comparison of Large AlON and Sapphire Windows, Proceedings of SPIE—The International Society for Optical Engineering, 1112[Window Dome Technol Mater.]: 31-9, 1989.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a secondary electron (SE) SEM micrograph taken from a green body (fracture surface) after polymer burnout from an AlON sample prepared using water-based pressure filtration.

FIG. 2 illustrates an XRD measurement of the AlON.

FIG. 3 illustrates the sintered densities duration for AlON as a function of sintering duration, which was measured using the Archimedes method.

FIGS. 4a-4c illustrate transparency results for pure AlON (FIG. 4a); AlON+dopant Y (FIG. 4b); and, AlON+dopant La (FIG. 4c).

FIG. 5 illustrates secondary electron (SE) SEM fractograph taken from a water-based pressure filtered sample which was sintered for 4 hours at 2000° C.

FIGS. 6a and 6b illustrates a SEM image displaying uniform distribution of residual porosity obtained by the water-based pressure filtration process (see FIG. 6b) compared with the alcohol-based methods (see FIG. 6a).

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide water-based method for processing aluminum oxynitride (AlON).

Hence, it is in the scope of the invention wherein a water-based method for producing AlON green bodies with high green density is described. While conventional methods use alcohol as a medium for ball-milling due to hydrolysis of AlN, this approach utilizes water to form a rigid network of aluminum hydroxide in green Al₂O₃—AlN preforms.

The present invention provides a new approach for processing AlON. The new approach is based on hydrolysis of AlN in water. This process was found to produce green bodies having a relatively high green density compared to other examined processes. The green density of samples prepared using water-based pressure filtration was more than 15% (30% increase in density, see table 1) higher than the conventional slip casting. In addition, this process results in a uniform distribution of residual porosity, compared to other methods which were used. However, due to the high sintering temperature, differences in the final densities were not observed.

The water based method comprises steps selected inter alia from:
a) ball-milling Alumina powder or Al₂O₃ and deflocculant in water for a period of time t; t is greater than about 10 hours and lower than about 24 hours;
b) homogeneously dispersing AlN in said ball-milled product for a period of time t1; t1 is greater than about 0.5 hours and lower than about 4 hours;
c) vacuum drying said product; thereby providing dense green bodies;
d) sintering said dense green bodies at temperature T1 in nitrogen for several time durations t2; T1 is greater than about 1700° C. and lower than about 2100° C.; t2 is greater than about 0.5 hours and lower than about 10 hours;
wherein the density of said sintered bodies is of at least 99% as measured according to ASTM C20-92; further wherein said the density of said green bodies is of at least 60% as measured by green density measurements.

The present invention another water based method for producing AlON. The method comprises steps selected inter alia from:
a) ball-milling Al₂O₃ and deflocculant in water for a period of time t3; said t3 is greater than about 10 hours and lower than about 48 hours;
b) homogeneously dispersing AlN in said ball milled product for a period of time t4; said t4 is greater than about 0.5 hours and lower than about 4 hours;
c) pressure filtering said product; thereby providing dense green bodies;
d) removing NH3 by vacuum drying said filtered slip;
e) performing polymer burnout at temperature T2; said T2 is greater than about 400° C. and lower than about 800° C.;
f) sintering the product of step (e) at temperature-T3 in nitrogen for several time durations t5; said t5 is greater than about 0.5 hours and lower than about 10 hours; said T3 is greater than about 1700° C. and lower than about 2100° C.;
wherein the density of said sintered bodies is of at least 99% as measured according to ASTM C20-92; further wherein said the density of said green bodies is of at least 60% as measured by green density measurements.

Furthermore, the present invention provides a compound comprising sintered Aluminum oxynitride (AlON), characterized by a density of at least 99% as measured according to ASTM C20-92.

Yet more, the present invention provides a compound comprising green dense Aluminum oxynitride (AlON), characterized by green density of at least 60% as measured by green density measurements.

Al₂O₃—AlN preforms were prepared by four different routes based either on alcohol or water-based slips, and underwent identical sintering procedures. The results indicate that samples prepared using the water-based method by pressure filtration reached a green density of 67%, compared to 52% and 47% for alcohol-based slips and 50% for conventional water-based slip-casting.

The term “ASTM C20-92” refers hereinafter to a testing method which is described in ASTM Standard Test Method C20-92, entitled “Apparent Porosity, Water Absorption, Apparent Specific Gravity, and Bulk Density of Burned Refractory Brick and Shapes by Boiling Water”. ASTM C20-92 is usually named the Archimedes method.

The term “about” refers hereinafter to a range of 5% below or above the referred value.

The term “Sintering” refers herein after to a method for preparing materials from powders, by heating the material (below its melting point) until its particles adhere to each other.

The term “green density” refers herein after to the density of the ceramic body before sintering.

The term “green density measurements” refers herein after to any density measurements such as, but not limited to, SEM micrographs combined with image processing software or simply by dividing the weight by the volume.

The term “density measurements” refers herein after to any density measurements such as, but not limited to, SEM micrographs combined with image processing software, Archimedes method or ASTM C20-92, densitometer, optical measurements, ASTM Standard D792-00, gravitometer, simply by dividing the weight by the volume.

The term “ASTM D792-00” refers hereinafter to a testing method which is described in ASTM Standard Test Method D792-00, entitled “Test Methods for Density and Specific Gravity (Relative Density) of Plastics by Displacement”.

The term “ball mill” refers to a method for mixing the ceramic powders with each other and with dopants and dispersant, using grinding balls. Due to the low energy used, the grinding is negligible.

The term “Hydrolysis Assisted Solidification (HAS)” refers herein after to a process for forming ceramic green bodies from aqueous suspensions which was patented by Kosmac et al. in 1995.

The present invention provides two new water based methods to prepare green bodies for reaction sintering.

The following four methods summaries two commonly used alcohol based methods and the two new water based methods proposed by the present invention:

First Method (Alcohol Based Method which is Commonly Used)

The first was based on ball-milling Al₂O₃ (Ceralox HPA-0.5, Tucson, Ariz.) and MN (Tokuyama grade F, Yamaguchi Japan) powders with binder (Zusoplast 92/5, Zschimmer & Schwarz, Lahnstein, Germany) and deflocculant (Dolapix CE 64, Zschimmer & Schwarz, Lahnstein, Germany) in ethanol for 24 hours. After drying, the slips were manually ground with a mortar and pestle and sieved to 70 □m. Green bodies were prepared by uniaxial pressing (60 MPa) the powders into 46 mm diameter disks with a thickness of 5 mm. Sintering was conducted at 2000° C. in nitrogen for several time durations.

### Second Method (New Water Based Method—According to the Present Invention)

In the second method, a water-based slip was prepared using high purity alumina powder (Ceralox HPA-0.5). The slip was ball milled for 24 h in water and deflocculant (Dolapix CE 64). AlN (Tokuyama grade F) was added after 22 hours in order to avoid the formation of aluminum hydroxide during the initial slip preparation stage. The slip was then cast into plaster moulds and dried in air. Sintering was conducted at 2000° C. in nitrogen for several time durations.

### Third Method (Alcohol-Based Pressure Filtration, Again Commonly Used).

In the third method pressure filtration of slips was used. In this method the slips is based on alcohol.

The starting powders of Al₂O₃ (Ceralox HPA-0.5), binder (Zusoplast 92/5) and AlN (Tokuyama grade F) were ball milled for 24 hours with deflocculant (Dolapix CE 64).

Pressure filtration was conducted to achieve dense green bodies (maximum pressure was 7 MPa) with a diameter of 45 mm and a thickness of 10 mm. The samples were dried in a vacuum desiccator in order to remove NH₃ which is released during the hydrolysis reaction. Polymer burnout was performed at 600° C. followed by sintering at a temperature of 2000° C. in nitrogen for several time durations.

### Fourth Method (Water Based Pressure Filtration Method)

In the fourth method pressure filtration of slips was used. In this method the slips is based on water.

The starting powders of Al₂O₃ (Ceralox HPA-0.5) and AlN (Tokuyama grade F) were ball milled for 24 hours with deflocculant (Dolapix CE 64). AlN was added after 22 hours.

Pressure filtration was conducted to achieve dense green bodies (maximum pressure was 7 MPa) with a diameter of 45 mm and a thickness of 10 mm. The samples were dried in a vacuum desiccator in order to remove NH₃ which is released during the hydrolysis reaction. Polymer burnout was performed at 600° C. followed by sintering at a temperature of 2000° C. in nitrogen for several time durations.

The sintered samples from all four methods were mechanically polished using 0.25 μm diamond polishing media. X-ray diffraction (XRD) was used to confirm the presence of γ-AlON. These measurements were acquired from polished specimens using a conventional X-ray powder diffractometer (Philips X'Pert Diffractometer, Eindhoven, Netherlands) with a Cu—K□ source, operated at 40 mA and 40 kV, and using 1° divergent and anti-scattering slits coupled with 0.2 mm receiving slits. A curved graphite monochromator)(2□=26.4° preceded the detector. Diffraction patterns were acquired at steps of 0.025° 2□ and 3.3 seconds/step exposure. The samples were also characterized by scanning electron microscopy (SEM, XL 30 and Quanta 200, FEL Electron Optics, Eindhoven, Netherlands). Residual pore size and location, and estimates of the sample density were measured from SEM micrographs using the INCA software package. The bulk density was measured using the Archimedes method (ASTM C20-92).

AlON samples were prepared by four different methods. The differences between these methods are only in the green body preparation process, while the sintering process is similar.

The HAS process is based on small additions of AlN to the ceramic slurry. In, the case of AlON, the AlN content is 30 at. %. In order to avoid hydrolysis during ball milling, the AlN powder was added only in the final two hours of ball milling. During this period, which was in the order of the incubation period, AlN was homogeneously dispersed in the slip, followed by the beginning of hydrolysis which ended during pressure filtration.

The following table, table 1, summarizes the green densities achieved by the four different processes.

TABLE 1
Green densities of AlON samples prepared by the four different methods.

| Method | Green Density [%] |
|---|---|
| Water-based | 67.4 ± 0.4 |
| pressure filtration (Fourth method) | |
| Alcohol-based | 52.2 ± 0.5 |
| pressure filtration (Third method) | |
| Water-based | 50 |
| slip casting (Second method) | |
| Alcohol-based | 47 |
| Press (First method) | |

From table 1, it can be seen that samples prepared by water-based pressure filtration provided by the present invention reached the highest green density, and there is 30% increase in density. As a result, densification of the water-based pressure-filtered samples is more complete. Reference is now made to FIG. 1, which illustrates a secondary electron (SE) SEM micrograph taken from a green body (fracture surface) after polymer burnout from an AlON sample prepared using water-based pressure filtration (density of 67.4%). Large contact areas between the powder grains are due to the rigid Al₂O₃ network, which was formed as Al(OH)₃ during the hydrolysis and transformed into Al₂O₃ during the polymer burnout. This rigid network improves the green body's mechanical properties and enables easier handling and machining to near final shape. These are the main advantages of the water-based process.

In addition, it can be seen that samples prepared by pressure filtration, both based on alcohol or water, achieved higher green densities.

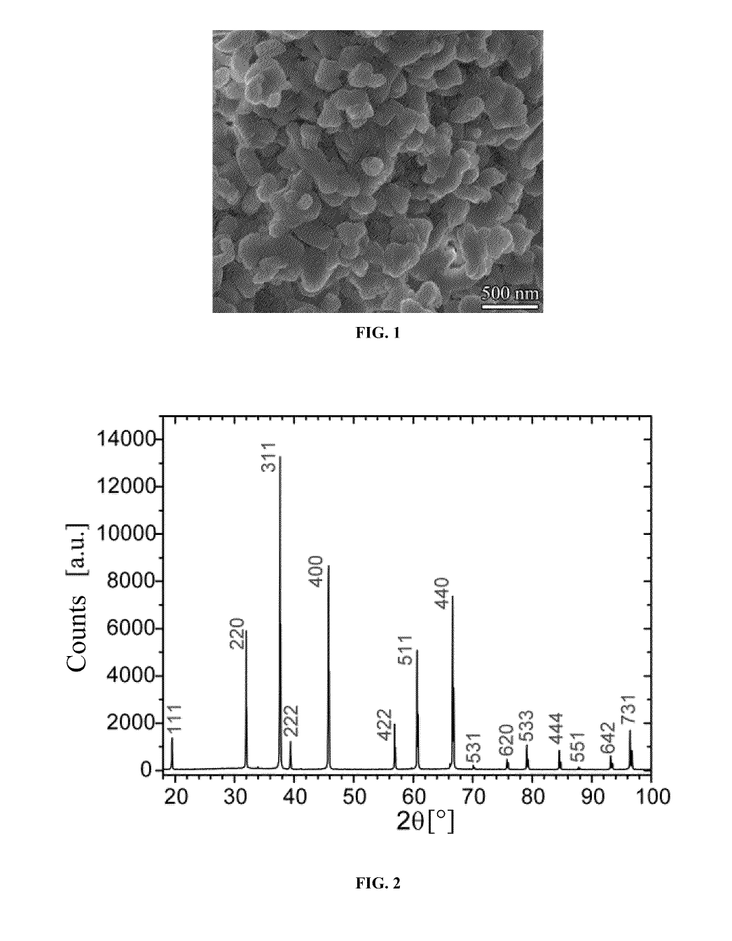

Reference is now made to FIG. 2, which illustrates an XRD measurement. The measurements show that the sintered samples contain only the □-AlON phase with no residual Al₂O₃ or AlN. The shortest sintering duration tested for all samples was 4 hours, during which the reaction was completed, which means that the reaction occurs in the initial stages of sintering at 2000° C. This is in good agreement with Bandyopadhyay et al. who found that the reaction is completed within less than 30 minutes at T≧1800° C.

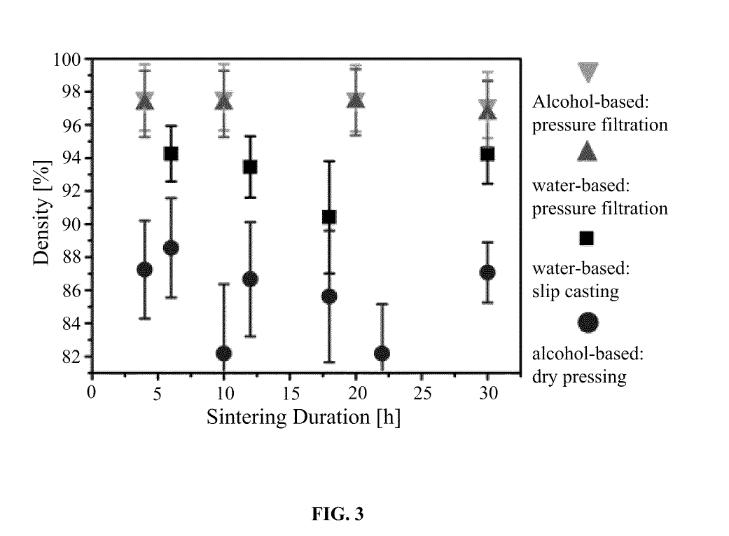

Reference is now made to FIG. 3, which illustrates the sintered densities duration for AlON as a function of sintering duration, which was measured using the Archimedes method. Samples prepared using pressure filtration reached the highest density, while the differences between the water-based and alcohol-based processes are within the measurement errors.

The measurement error is relatively large, due to the samples' dimensions, which results in the error in weight to be significant (this method is optimized for large bricks). Krell et al. measured the density of transparent Al₂O₃ using the Archimedes method as well, and found this method not to be accurate enough for high densities and small differences between the samples. Sintered densities were also evaluated from SEM micrographs, and the results were similar to the Archimedes measurements. Samples prepared by dry pressing (alcohol-based) had the lowest densities. This is the main advantage of the water-based process, which is probably, due to the differences in the green densities. In addition, increasing the sintering duration from 4-hours to 30 hours did not affect the density, while the grain size increased from ˜50 □m to ˜200 □m. Maghsoudipour et al. found that the shrinkage increases with temperature during sintering up to 1800° C. and remains constant above this temperature. Martin and Cales found that annealing at 1950° C. following sintering results only in grain growth without any improvement in density or transparency. This correlates with the lack of densification with increasing sintering duration at 2000° C.

Another important issue is the transparency of the obtained samples.

In addition to the fact that samples prepared using the pressure filtration process reached very high densities even after 4 hours at 2000° C., their transparency experiments gave excellent results.

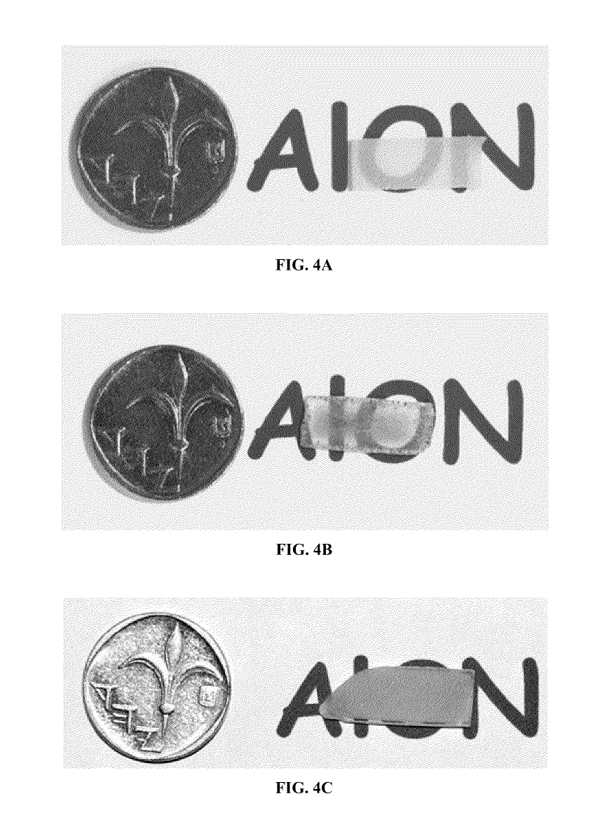

Reference is now made to photographs 4a-4c which present the transparency results for pure AlON (FIG. 4a), AlON with dopants+dopant Y (FIG. 4b) and AlON+dopant La (FIG. 4c). It should be emphasized that in both FIGS. 4b and 4c the AlON grains were saturated with Y or La, i.e., they are at the solubility limit.

It should be further emphasized that other samples prepared have reached transparency of about 80%.

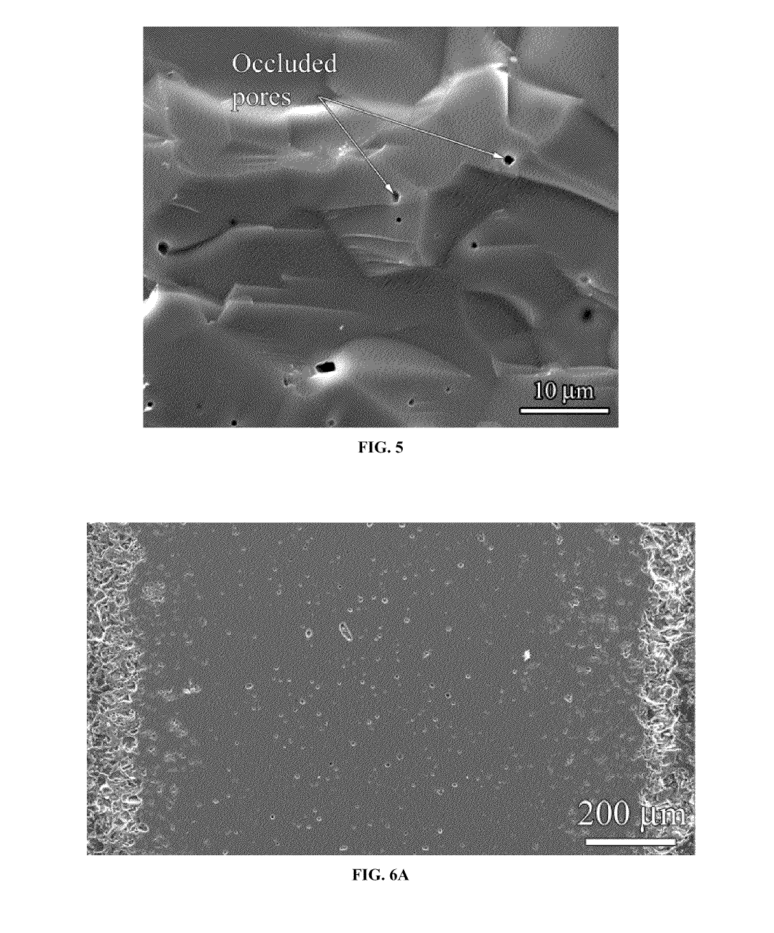

Reference is now made to FIG. 5, which illustrates SE SEM fractograph taken from a water-based pressure filtered sample which was sintered for 4 hours at 2000° C. The sample contains some occluded pores, as well as some larger pores located at grain boundaries. The residual pores, visible in FIG. 5, were mainly found within the AlON grains (occluded) rather than at grain boundaries, which makes their elimination difficult. This also indicates that 2000° C. is probably too high a sintering temperature, which results in a higher grain boundary mobility compared to pore mobility.

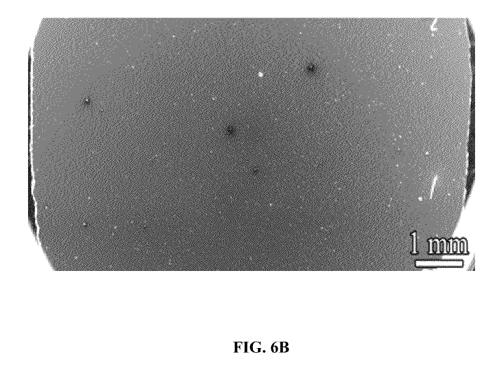

Another issue which should be taken into account is the distribution of residual pores. While a sample prepared using the alcohol-based dry pressing process had a density gradient from the center to the external surface (see FIG. 6a), a sample prepared using the water-based pressure filtration process had a uniform density over the entire cross-section (see FIG. 6b). This is also an advantage of the pressure filtration method, which enables a higher mobility of the powder particles through the slip during pressing.

As described above, the present invention provides a new approach for processing AlON. The new approach is based on hydrolysis of AlN in water. This process was found to produce green bodies having a relatively high density compared to other examined processes. The green density of samples prepared using water-based pressure filtration was more then 15% higher. In addition, this process results in a uniform distribution of residual porosity, compared to other methods which were used. However, due to the high sintering temperature, differences in the final densities were not observed.

It is further in the scope of the invention wherein the solubility limits of La and Y in aluminum oxynitride (AlON) at 1870° C. is disclosed.

Hence, it is in the scope wherein solubility limits of Lanthanum (La) and Yttrium (Y) in AlON were measured using wavelength dispersive spectroscopy mounted on a scanning electron, microscope, from samples quickly cooled from 1870° C. AlON samples were prepared with dopant concentrations well above the solubility limit, which was confirmed by X-ray diffraction, backscattered electrons micrographs and wavelength dispersive spectroscopy. Measurements were conducted on polished samples without thermal or chemical etching. The results indicate solubility limits of 498±82 ppm and 1775±128 ppm for La and Y in AlON at 1870° C., respectively. The solubility limit of Magnesium (Mg) in AlON at 1870° C. was found to be greater than 4000 ppm.

It is acknowledged that aluminum oxynitride (AlON) is a polycrystalline ceramic material with potential use in applications requiring high strength combined with optical transparency. Due to its cubic spinel structure, polycrystalline AlON has isotropic optical and thermal properties, making it a candidate material to replace single crystal, forms of oxides currently in use for optical applications.

In order to achieve optical transparency full density is required, and as a result the sintering process for AlON usually includes elevated temperatures combined with pressure and/or long sintering durations. To overcome this difficulty and for controlling microstructural evolution, dopants are often introduced:

The solubility of these elements (La, Y and Mg) in ceramics is usually very low (assumed to be in the order of tens to hundreds of ppm), which results in their enrichment to grain boundaries and interfaces even at very low doping levels. There are several reports regarding solubility limits in ceramics, and many of them are based on alumina as a model system. Grimes made atomistic calculations in order to predict the solution energies of MgO, CaO and TiO₂ in alumina and compared his results to experimental data. He found a correlation between the solution energies and the preferred compensation mechanisms, and the cation size. Miller et al. measured the solubility limit of MgO in alumina at 1600° C. The measurements were based on an alternative approach to measuring the solubility limits in polycrystalline ceramics, based on wavelength-dispersive spectroscopy (WDS) of saturated polycrystalline specimens, rapidly quenched from a high temperature.

The major dopants of interest for AlON are La, Y and Mg. However, their solubility limits in AlON have not been measured to date. This work determines the solubility limits of La and Y in AlON in a direct and accurate way, and correlates between these solubilities and the dopant size. The samples were prepared by ball milling high purity alumina powder (Ceralox HPA-0.5, Tucson, Ariz.), deflocculant (Dolapix CE 64, Zschimmer & Schwarz, Lahnstein, Germany) and 5 at. % of La(NO₃)₂.6H₂O (Fluka Chemika, Switzerland), Y(NO₃)₃.5H₂O (Aldrich Chemical Company, Milwaukee, USA) or Mg(NO₃)₂.6H₂O (Riedel-de Han, Germany) for 24 hours using alumina balls (99.5% purity). A high concentration of dopants was used to ensure a bulk concentration well above the solubility limits. AlN (Tokuyama grade F, Yamaguchi Japan) was added after ˜22 hours in order to avoid the formation of aluminum hydroxide during the initial slip preparation stage. Pressure filtration was performed in order to produce densed green bodies (maximum pressure 7 MPa) with a diameter of 45 mm and a thickness of 7 mm. The samples were sintered at a temperature of 1870° C. in nitrogen for 24 hours to achieve homogeneous dispersion of the dopants within the AlON sample. Following sintering, the samples were rapidly cooled at ˜50° C./min to 870° C., followed by cooling at ˜10° C./min to room temperature. The sintered samples were mechanically polished using 0.25 vim diamond polishing media. X-ray diffraction (XRD) was used to confirm the presence of γ-AlON and a second phase, which confirms that AlON is saturated with the specific dopant. The solubility limit at the sintering temperature was determined from the rapidly-cooled samples. WDS measurements were conducted on interior sections of the specimens (not the free surface), after mechanical polishing to a 0.25 □m surface finish (diamond polishing media). No chemical or thermal etching was performed in order to prevent possible changes in the local concentration. An XRD pattern was acquired from a La-doped AlON sample. Reflections from LaAl₁₁O₁₈ indicate that the AlON grains were saturated with La, i.e., they are at the solubility limit. A similar result was acquired from the Y-doped AlON sample where Y₂O₃ was detected as the second phase meaning that the AlON grains were saturated with Y. For the Mg-doped AlON samples, no secondary phases were detected by XRD, meaning that the AlON grains were below the solubility limit.

SEM micrographs were taken from the La-doped AlON sample. A SEM micrograph of a polished sample with no chemical or thermal etching. WDS measurements were acquired from this sample. There is a very clear contrast between the AlON matrix and the LaAl₁₁O₁₈ platelets due to the large density differences between the two phases, and dark (AlON phase) large areas can also be observed. This allows to raster the electron beam within the AlON grains, which prevents overlapping with the LaAl₁₁O₁₈ phase. However, there may be some overlapping with grain boundaries that can not be seen during the measurement, which will increase the standard deviation.

SEM fractographs were taken from this sample, showing the shape and the homogeneous distribution of the LaAl₁₁O₁₈ phase within the AlON matrix.

WDS measurements conducted on this sample resulted in a solubility limit of La in AlON of 498±82 ppm.

SEM micrographs were taken from the Y-doped AlON sample, showing a polished surface (a) and fractographs (b and c).

WDS measurements conducted on this sample resulted in a Y solubility limit in AlON of 1775±128 ppm.

A set of (a) BSE and (b) SE SEM fractographs was acquired from the Mg-doped AlON sample which was sintered at 1870° C. for 24 hours. In both micrographs no secondary phases are observed, indicating that the AlON grains are below the solubility limit (which is in agreement with XRD results). WDS measurements conducted on this sample show a very large distribution of around 4000 ppm which indicates the solubility limit of Mg in AlON is greater than 4000 Ppm.

Since there is no data in the literature regarding doping and solubility limits in AlON, Al₂O₃ was used as a model, system for comparison. Grimes calculated the solution energies of Ca, Si and Ti in Al₂O₃ and found that larger cations have higher solution energies and hence lower solubility limits. Bae and Baik estimated the heat of solution for CaO and SiO₂ in Al₂O₃ and found a correlation between larger cation dopants and higher heats of solution, and hence lower solubility limit. In the present invention, a correlation between the solubility limits and the cation dopant size (according to the WDS results) was found, in agreement with Grimes and Bae and Baik.

Regarding Al₂O₃, Si and Ca dopants are known to promote abnormal grain growth (AGG), while Mg doping results in a normal grain growth (NGG). In the present application, La-doped AlON and Mg-doped AlON resulted in NGG with a grain size of ˜40, while the Y-doped AlON resulted in AGG of some very large grains (˜500 □m) and a large number of smaller grains (˜20 □m).

Due to the high sintering temperature and long sintering duration, diffusion was faster, which resulted in large AlON grains. This enables to rasterize the electron beam (and the interaction volume) within the AlON grain without overlapping with grain boundaries and secondary phase particles.

In addition, the secondary phases in this case are much heavier than the AlON matrix, and hence their BSE contrast is much brighter. These two reasons increased the measurement precision and the number of measurements could be decreased. On the other hand, due to the high temperature and long sintering duration, Mg evaporated from the AlON sample during sintering and the Mg-doped AlON sample was below the solubility limit (the Mg-rich phase was not detected either by XRD or SEM). Hence, in order to measure the Mg solubility limit, the starting doping level should be higher.

Another issue which should be taken into account is the cooling rate. Due to the high sintering temperature, the sintering process was conducted in a resistance furnace with graphite elements. Hence, the furnace door could not be opened at the end of the sintering process and water quenching could not be performed. The cooling rate was obtained by the water chiller after turning the furnace off, which resulted in a lower cooling rate of ˜50° C./minute for the first 1000° C., which decreased to ˜10° C./minute at lower temperatures. This low cooling rate may have resulted in a diffusion of dopants from the AlON grains during cooling, and the measured solubility limits may be lower, as was seen in the Al₂O₃ experiments.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1-30. (canceled)

31. A compound comprising sintered Aluminum oxynitride (AlON) having a density of at least 99% as measured according to ASTM C20-92.

32. A compound comprising green dense Aluminum oxynitride (AlON) having a green density of at least 60% as measured by green density measurements.

33. A water-based method for producing Aluminum oxynitride (AlON) green bodies with a relatively high green density, said method comprising steps of:
a. ball-milling Alumina powder or Al₂O₃ and deflocculant in water for a period of time t;
b. homogeneously dispersing AlN in said ball-milled product for a period of time t1;
c. vacuum drying said product; thereby providing dense green bodies; and
d. sintering said dense green bodies at temperature T1 in nitrogen for several time durations t2; wherein density of said sintered bodies is at least 99%, particularly at least 95%, as measured according to ASTM C20-92 and wherein density of said green bodies is at least 60% as measured by green density measurements.

34. The method according to claim 33, wherein said period of time t is greater than about 0.5 hours and lower than about 48 hours.

35. The method according to claim 33, wherein said temperature T1 is greater than about 1700° C. and lower than about 2100° C.

36. The method according to claim 33, wherein said time duration t2 is greater than about 0.5 hours and lower than about 10 hours.

37. The method according to claim 33, wherein said time duration t1 is greater than about 0.5 hours and lower than about 4 hours.

38. The method according to claim 33, wherein said step of sintering additionally comprises a step of applying pressure of about 10-20 MPa.

39. The method according to claim 33, wherein said deflocculant is selected from the group consisting of poly acrylic acid.

40. Aluminum oxynitride (AlON) green bodies having high green density, prepared by steps of:
a. ball-milling Alumina powder and deflocculant in water for a period of time t, wherein t is greater than about 10 hours and lower than about 24 hours;
b. homogeneously dispersing AlN in said ball-milled product for a period of time t1; wherein t1 is greater than about 0.5 hours and lower than about 4 hours;
c. vacuum drying said product, thereby providing dense green bodies; and
d. sintering said dense green bodies at temperature T1 in nitrogen for several time durations t2, wherein t2 is greater than about 0.5 hours and lower than about 10 hours, wherein T1 is greater than about 1700° C. and lower than about 2100° C.; and further wherein density of said sintered bodies is at least 95% as measured according to ASTM C20-92 and density of said green bodies is at least 50% as measured by green density measurements.

41. The method according to claim 33, additionally comprising a step of adding about 1 wt % of dopant selected from the group consisting of MgO dopant in a form of salt and soluble in water; La₂O₃ dopant in a form of salt and soluble in water; Y₂O₃ dopant in a form of salt and soluble in water; and combinations thereof.

42. The method according to claim 33, additionally comprising a step of pressure filtering said product; thereby providing dense green bodies.

43. The method according to claim 33, additionally comprising a step of removing NH₃ by vacuum drying said dense green bodies.

44. The method according to claim 33, additionally comprising a step of performing polymer burnout at temperature T2, wherein T2 is greater than about 400° C. and lower than about 800° C.

45. The method according to claim 44, additionally comprising a step of sintering the product at temperature T3 in nitrogen for several time durations t5, wherein T3 is greater than about 1700° C. and lower than about 2100° C. and t5 is greater than about 0.5 hours and lower than about 10 hours.

46. A compound comprising green dense Aluminum oxynitride (AlON) having a green density of at least 67% as measured by green density measurements.

47. The method according to claim 42, wherein said step of pressure filtering is performed at about 7 MPa.

48. The method according to claim 45, wherein said step of sintering additionally comprises a step of applying pressure of about 10-200 MPa.

49. An article of manufacturing comprising a compound having green dense Aluminum oxynitride (AlON), wherein said AlON has a green density of at least 60% as measured by green density measurements.

50. An article of manufacturing comprising a compound having sintered Aluminum oxynitride (AlON), wherein said sintered AlON has a density of at least 99% as measured according to ASTM C20-92.
